(19) United States
(12) Patent Application Publication
(10) Pub. No.: US 2014/0164090 A1
(43) Pub. Date: Jun. 12, 2014

(54) GREEN LIFE MANAGEMENT METHOD AND SYSTEM

(71) Applicants: Seung Joon Yoon, Seoul (KR); Sung Sik Moon, Seoul (KR)

(72) Inventors: Seung Joon Yoon, Seoul (KR); Sung Sik Moon, Seoul (KR)

(73) Assignee: KOREA ENVIRONMENT INDUSTRY TECHNOLOGY INSTITUTE CO., LTD., Seoul (KR)

(21) Appl. No.: 14/234,113

(22) PCT Filed: May 17, 2012
(86) PCT No.: PCT/KR2012/003896

§ 371 Date: Jan. 21, 2014

(51) Int. Cl. G06Q 30/02

(52) U.S. Cl. CPC G06Q 30/0226
USPC 705/14.27

(57) ABSTRACT

The present invention relates to a method and system for managing the green life of a user. The present invention provides a green life management system managing a green life of a user by using a card medium of the user, comprising: a card reader terminal (100) configured to read card medium information of the card medium, and a management server (200) configured to communicate with the card reader terminal and receive the card medium information, wherein the management server comprises: a first green life management unit (240) configured to receive energy consumption information of the user, calculate points based on the card medium information and the energy consumption information, and transmit the points to a point management unit (230), a second green life management unit (250) configured to receive a product purchase list of the user, extract a green product list from the product purchase list, calculate points based on the card medium information and the green product list, and transmit the points to the point management unit, and the point management unit (230) configured to accumulate the received points in an account of the user, classify the accumulated points based on the energy consumption information and the green product list, and transmit details about the classification to a user terminal of the user.

### TECHNICAL FIELD

The present invention relates to a method and system for managing the green life of a user and, more particularly, to a method and system for managing the green life of a user by using a medium enabling the user to be easily identified, thus allowing green life culture to be ultimately established.

### BACKGROUND ART

Recently, the protection of the environment has become an issue. Therefore, various systems for protecting the environment have been established and promoted. An example of such a system is a green life which has been emphasized and encouraged. The term “green life” denotes a life which perceives seriousness in weather variations, reduces energy consumption in daily life, and then minimizes the emissions of greenhouse gases and pollutants.

An example of a green life may be the case of using green products in daily life. The term “green product” denotes a product for minimizing the investment in energy and resources and the emissions of greenhouse gases and pollutants.

However, in many cases, production of these green products outstrips their consumption. For example, hybrid vehicles for reducing the emissions of harmful gasses more than do existing vehicles have been developed and produced, but production companies invest a considerable amount in the development of hybrid vehicles, thus increasing the prices of hybrid vehicles with the result that consumers feel a burden in purchasing hybrid vehicles. As in this case, there are many cases where green products are expensive, so that typical consumers refrain from purchasing green products.

However, plans currently presented to realize the green life are focused merely on increasing the production of green products, but do not present methods of increasing their consumption. As an example, Korean Registered Patent Publication No. 10-992398 discloses biodegradable filament nonwoven fabric that can reduce the generation of carbon, that is, can be utilized as a green product. However, this publication focuses only on a manufacturing method or a product itself, and, in other words, relates to the production of green products and does not present a method of increasing the consumption of these green products. In this way, the production scale of green products continuously increases (1.6 trillion Won in 2004, but increases to the scale of 26 trillion Won in 2010). However, unlike this tendency, the intention or behavior of typical consumers to consume green products is still lacking.

Further, as another example of a green life, plans for reducing greenhouse gas emissions in daily life have been presented. Most of plans that are currently being enforced are methods of limiting the greenhouse gas emissions of manufacturing companies. However, since a non-industrial part actually occupies a large portion of greenhouse gas emissions, the efforts of the non-industrial part excluding manufacturing companies, that is, of typical consumers, are required to reduce greenhouse gas emissions. However, typical consumers, who do not feel a necessity to practice a green life, scarcely practice the reduction of greenhouse gases. That is, there is a problem in that it is difficult to realize real green life culture using only existing plans for developing green products or reducing the greenhouse gas emissions of manufacturing companies.

As described above, since typical consumers cannot be made aware of the necessity to practice a green life and are actually inconvenienced by executing methods of practicing a green life or when practicing the green life, the consumers become non-receptive to practicing the green life and a lot of problems may arise in establishing the green life culture. Therefore, there is a need to encourage the green life by enabling the green life to be easily practiced and by providing benefits based on the practice of the green life.

### DISCLOSURE OF INVENTION

### Technical Problem

Accordingly, the present invention has been made keeping in mind the above problems occurring in the prior art, and an object of the present invention is to efficiently manage the green life of typical consumers.

Another object of the present invention is to enable the green life to be conveniently practiced using a card medium.

A further object of the present invention is to provide a green life consumption platform using a card medium.

Yet another object of the present invention is to implement a low-carbon green society by realizing the habitual use of green products by a nation and the promotion of a green life using a card medium.

Still another object of the present invention is to provide a method of allowing even typical consumers as well as distributors or manufacturers to easily practice a green life, thus enabling green life culture to be established.

Still another object of the present invention is to rouse in the user the necessity to protect the environment while practicing a green life.

Still another object of the present invention is to present guidelines for practicing a green life.

Still another object of the present invention is to add a function capable of practicing a green life to an existing card medium, thus improving convenience when practicing the green life.

### Solution to Problem

The present invention relates to a method and system for managing a green life.

The present invention provides The present invention provides a green life management system managing a green life of a user by using a card medium of the user, comprising: a card reader terminal configured to read card medium information of the card medium, and a management server configured to communicate with the card reader terminal and receive the card medium information, wherein the management server comprises: a first green life management unit configured to receive energy consumption information of the user, calculate points based on the card medium information and the energy consumption information, and transmit the points to a point management unit, a second green life management unit configured to receive a product purchase list of the user, extract a green product list from the product purchase list, calculate points based on the card medium information and the green product list, and transmit the points to the point management unit, and the point management unit configured to accumulate the received points in an account of the user, classify the accumulated points based on the energy consumption information and the green product list, and transmit details about the classification to a user terminal of the user.

### Advantageous Effects of Invention

According to the above-described present invention, the green life of typical consumers can be efficiently managed.

Further, according to the present invention, the green life can be conveniently practiced using a card medium.

Furthermore, according to the present invention, a green life consumption platform can be provided using a card medium.

Furthermore, according to the present invention, a low-carbon green society can be implemented by realizing the habitual use of green products by a nation and the promotion of a green life using a card medium.

Furthermore, according to the present invention, a method of allowing even typical consumers as well as distributors or manufacturers to easily practice the green life is provided, thus attracting voluntary participation in practicing the green life and enabling green life culture to be established.

Furthermore, according to the present invention, the necessity to protect the environment while practicing a green life can be roused.

Furthermore, according to the present invention, guidelines for practicing a green life can be presented.

Furthermore, according to the present invention, a function capable of practicing a green life is added to an existing card medium, thus improving convenience when practicing the green life.

Furthermore, according to the present invention, points that are individually paid to different types of green lives can be unified and managed, thereby facilitating the practice of the green life.

### BRIEF DESCRIPTION OF DRAWINGS

FIG. 1 is a diagram showing a green life management system according to an embodiment of the present invention;

FIG. 2 is a schematic block diagram showing a management server according to an embodiment of the present invention;

FIGS. 3 and 4 are flowcharts showing the operation of the green life management system according to an embodiment of the present invention;

FIG. 5 is a diagram showing the management of greenhouse gases according to an embodiment of the present invention;

FIG. 6 is a diagram showing the management of a green product according to an embodiment of the present invention;

FIG. 7 is a diagram showing the management of a public sector according to an embodiment of the present invention; and

FIG. 8 is a diagram showing accumulated points according to an embodiment of the present invention.

### MODE FOR THE INVENTION

The advantages and features of the present invention and methods for accomplishing them will be more clearly understood from the detailed description of the following embodiments taken in conjunction with the accompanying drawings. However, the present invention is not limited to the following embodiments which will be disclosed later, but may be implemented in various different forms. Those embodiments are provided to make the disclosure of the present invention complete and to completely notify those skilled in the art of the scope of the present invention. The scope of the present invention is defined only by the scope of the accompanying claims. The same reference numerals are used throughout the different drawings to designate the same or similar components.

Throughout the entire specification, a representation indicating that a certain part “includes” a certain element means that more elements may be further included in the certain part without excluding other elements unless a description to the contrary is specifically pointed out.

Throughout the entire specification, green life includes a greenhouse gas reduction, green product purchase, green consumption and public sector usage.

The present invention relates to a method and system for efficiently managing the green life of a typical consumer so as to encourage the green life of the typical consumer.

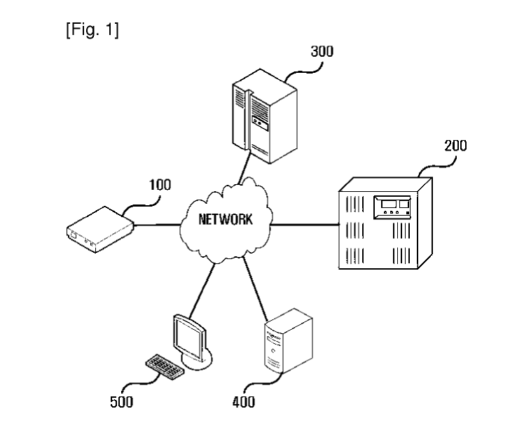

In FIG. 1, a green life management system S according to an embodiment of the present invention is shown. The present invention is not necessarily limited to this embodiment, and may be applied to any type of systems and apparatuses capable of performing payment using a card medium enabling a user to be identified.

As shown in FIG. 1, the green life management system S includes a card reader terminal 100, a management server 200, an energy measurement terminal 300, an affiliated company terminal 400, and a user terminal 500. The card reader terminal 100, the management server 200, the energy measurement terminal 300, the affiliated company terminal 400, and the user terminal 500 are connected to one another over a network (a wired or wireless network) and are capable of communicating with one another. Each of the card reader terminal 100, the energy measurement terminal 300, the affiliated company terminal 400, and the user terminal 500 may be implemented as a plurality of terminals. However, for the sake of description, such a terminal is assumed to be implemented as a single terminal, and then the embodiments of the present invention will be described below.

The card reader terminal 100 registers a card medium, reads the card medium, reads card medium information from the card medium, and transmits the read card medium information to the management server 200. Here, the term “card medium” denotes a medium for identifying each user, and may be, for example, a credit card, a check card, a debit card, a membership card, or such a card implemented in a mobile device, wherein a plurality of cards may be present per user. Such a card medium may include a card medium information unit (not shown) and the card medium information unit may include card medium information. The card medium information may include information required to identify a relevant card medium, and includes, for example, the type of card (whether a relevant card is a card required to manage the green life of a card user), features, a card issuance institution, a card identification (ID) number, and card user information (the ID of the user, personal file information, a card medium (or card media) held by the user, etc.). Also, the card medium information may include the location information of the card medium (for instance, if the card medium is implemented in a user terminal, the location information of the user terminal is regarded as the location information of the card medium). The card medium information unit for storing the card medium information may be implemented in the form of a magnetic stripe or an Integrated Circuit (IC) chip. Thus, when a new card medium is issued to the user, the card medium information of the new card medium is stored in the card medium information unit of the new card medium or is additionally stored in the card medium information unit of the existing card medium previously held by the user, thus enabling the user's green life to be managed using the card medium.

In accordance with an embodiment of the present invention, the card reader terminal 100 reads card medium information of the card medium and transmits the card medium information to the management server 200, or determines based on the card medium information that the card medium is related to the green life management of the card medium holder and transmits the card medium information of the card medium to the management server 200. The management server 200 may identify a user and manage the green life of the user using the card medium information.

Further, the card reader terminal 100 may transmit additional information (for example, a product purchase list, the location information of the card medium, the location information of the card reader terminal, terminal identification information, or the like), together with the card medium information, to the management server 200. In regard to this, the card reader terminal 100 has terminal identification information, and this terminal identification information may be managed by the management server 200. Location information matching the terminal identification information may also be managed by the management server 200. Therefore, for example, when the user uses the card medium, the card reader terminal reading the card medium may transmit additional information, such as a product purchase list related to the user or the location of the card medium or the card reader terminal, together with the card medium information, to the management server 200.

Further, in the case where a request is received from the user of the card medium when the card medium accesses the card reader terminal 100, the card reader terminal 100 may transmit the request, together with the card medium information, to the management server 200. For example, when the user makes a purchase request for a green product while using the card medium, the card reader terminal 100 reading the card medium may transmit the request, together with the card medium information of the card medium, to the management server 200.

Meanwhile, the management server 200 processes information or requests received from the card reader terminal 100, the energy measurement terminal 300, the affiliated company terminal 400, and the user terminal 500 which communicate with the management server 200 over the network. Such a management server 200 will be described in detail later.

Meanwhile, the energy measurement terminal 300 measures the amount of greenhouse gas emissions. That is, in consideration of the fact that greenhouse gases are emitted when a human being uses energy, the energy measurement terminal 300 measures the energy consumption of the user corresponding to the card medium, that is, the amount of electricity, water and gas consumed, thus indirectly measuring the amount of greenhouse gas emissions. The energy measurement terminal 300 may include, for example, an electric meter, a water meter, a gas meter, etc. Further, the energy measurement terminal 300 may also measure the amount of garbage generated. The energy measurement terminal 300 may transmit the measured energy consumption to the management server 200 as energy consumption information.

Further, the energy measurement terminal 300 may include the user information or the card medium information of the user while measuring the energy consumption of the user. Through this procedure, the energy measurement terminal may transmit the energy consumption information, together with the card medium information (or the user information), to the management server 200. That is, the energy measurement terminal 300 measures the energy consumption of a relevant user, and transmits to the management server 200 the energy consumption information, together with the card medium information (or the user information) of a card medium corresponding to the user, either periodically or when a request is received from the management server 200, thus allowing the management server 200 to store the energy consumption information in the account of the user.

Meanwhile, the affiliated company terminal 400 registers green consumption information, green product information or public sector information in the management server 200 to the management server 200.

The term “affiliated company” denotes a manufacturer, distributor, a local autonomous entity or a public institution which provides the green consumption encouragement service, the green products, or the public sector service. Such an affiliated company may register products, facilities or services provided thereby in the management server 200 via the affiliated company terminal 400.

Meanwhile, the user terminal 500 includes all devices that allow the user to access the green life management system S, and may generally be an electronic terminal. For example, the user terminal 500 may be any of a console, a cellular phone, a Personal Computer (PC), a tablet computer, a mobile communication terminal, a notebook computer, and a Personal Digital Assistant (PDA) terminal The user may access the green life management system S via the user terminal 500 and check contents of his or her account, for example, information about accumulated points or the like.

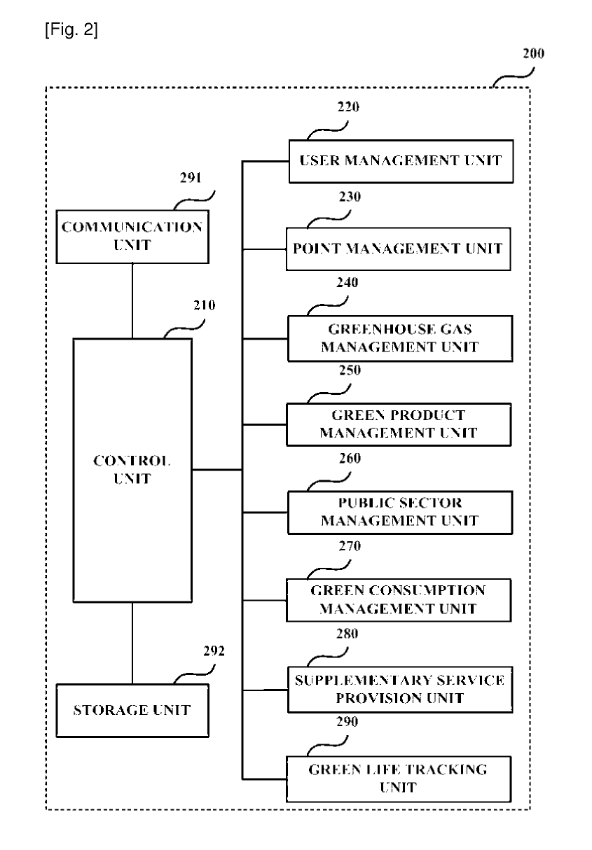

FIG. 2 is a schematic block diagram showing the management server 200 according to an embodiment of the present invention.

The management server 200 includes a control unit 210, a user management unit 220, a point management unit 230, a greenhouse gas management unit 240, a green product management unit 250, a public sector management unit 260, a green consumption management unit 270, a supplementary service provision unit 280, a green life tracking unit 290, a communication unit 291, and a storage unit 292.

The control unit 210 determines the operation of the management server 200 on the basis of information received from a card reader terminal 100. That is, when a request together with card medium information are received from the card reader terminal 100, the control unit 210 may transmit the card medium information to the user management unit 220, so that the account of the user of the card medium is identified and an operation corresponding to the request is processed.

Meanwhile, the user management unit 220 identifies the card medium from the received card medium information, identifies the user corresponding to the card medium, and manages the account of the user. That is, when receiving the card medium information from the control unit 210, the user management unit 220 may extract an identifier required to identify the card medium from the card medium information, and create or identify and manage the account of a user corresponding to the card medium on the basis of the identifier. For example, when a plurality of card media correspond to the same account (that is, one user), the user management unit 220 determines that the plurality of card media are bound to integrate points, and performs management such that accumulated/subtracted points for each of the card media are included in the account.

The point management unit 230 manages the points accumulated in the account corresponding to the user. Here, the term “point” denotes the compensation paid to the user using various methods of allowing the user to practice a green life as well as the compensation paid by a card company for the usage of the card by the user. For example, the points may be cash, virtual money, or a coupon enabling a discount to be provided. For example, the point management unit 230 may accumulate relevant points in the account of the user depending on the point information received from other components 210, 220, 240, 250, 260, 270, 280, 290, 291, and 292. Alternatively, when a serial number printed on a coupon provided together with a green product, is input from the user terminal 500, the point management unit 230 may accumulate points identical to an amount of money corresponding to the serial number in the account of the user. The point management unit 230 manages the points in an integrated manner.

Further, when a payment request is received, the point management unit 230 may perform a payment using a method of subtracting points. Furthermore, the point management unit 230 may extract the account of the user from a personal information file stored in the account of the user, and repay an amount of money corresponding to the points in cash to the user.

Further, the point management unit 230 may subtract points from those accumulated by the user when the user practices an anti-green life. For example, when energy consumed by the user increases, when the user does not use a green product for a predetermined period of time, or when the user does not conduct green consumption for a predetermined period of time, the points of the user may be subtracted.

The greenhouse gas management unit (first green life management unit) 240 obtains the points to be awarded to the user and accumulates the points in the account of the user on the basis of the energy consumption information received from the energy measurement terminal 300 so as to encourage the user to reduce his or her energy consumption, thus consequently prompting the user to reduce greenhouse gas emissions made by the user. In this case, the greenhouse gas management unit 240 may request energy consumption information from the energy measurement terminal 300 and then receive the energy consumption information. Further, the greenhouse gas management unit 240 may receive energy consumption information whenever the user utilizes the card medium, or periodically or randomly. The greenhouse gas management unit 240 allows the user to practice a green life by managing the greenhouse gas emissions of the user. That is, in order to cause the user to reduce energy consumption, the greenhouse gas management unit 240 pays points to the user on the basis of the energy consumption information received from the energy measurement terminal 300, and as a result, induces the user to reduce greenhouse gas emissions. Here, the term “greenhouse gas” denotes materials, for example, carbon dioxide (CO2), methane (CH4), nitrous oxide (N2O), hydrofluorocarbons (HFCs), Perfluorocarbons (PFCs), sulphur hexafluoride (SF6), and other materials for causing the greenhouse effect by absorbing or reemitting an infrared radiation among gaseous materials contained in an atmosphere. Such greenhouse gases are emitted when energy is consumed. For example, when water is used via a tap, electric energy for operating a pump or the like is required so that the water can come from the tap, and fossil energy is burned to generate such electric energy. Greenhouse gases are emitted due to the consumption of such fossil energy. Therefore, the greenhouse gas management unit 240 can calculate the amount of greenhouse gas emissions from the measured energy consumption. For example, in the case of electricity, carbon dioxide of 424 g per kw/h(kilowatt/hour) is emitted, so that it can be seen that when the user uses electricity of 10 kw/h for one hour, the user generates carbon dioxide of a total of 4240 g.

That is, the greenhouse gas management unit 240 may calculate the amount of greenhouse gases emitted by the user, that is, a measured value, on the basis of the energy consumption information received from the energy measurement terminal 300, and compare the measured value with a reference value, and then calculate the points to be assigned to the user. Here, the measured value may be set to energy currently being consumed by the user. However, in order to induce the user to continuously protect the environment, the measured value may preferably be set to energy consumed by the user over a predetermined period. For example, the measured value may be set to the average of energy consumption over the last six months. Further, the reference value may be set to a random value, but may preferably be set to the average of energy consumed by the user over a predetermined period so as to induce the user to continuously protect the environment. For example, the reference value may be set to the average of energy consumption over the last two years. In order to increase a greenhouse gas reduction rate, the predetermined period required to obtain the reference value may preferably be longer than the predetermined period required to obtain the above measured value (it is possible to calculate the reduction rate only when comparing the past energy consumption with the current energy consumption). When the measured value is less than the reference value (that is, when the energy consumption rate decreases (when the greenhouse gas reduction rate increases), the greenhouse gas management unit 240 transmits points to the point management unit 230 as the compensation for the reduction of the energy consumption rate so that the points are accumulated in the account of the user.

Further, the greenhouse gas management unit 240 may be motivated to reduce greenhouse gas emissions by increasing the payment rate of points as the greenhouse gas reduction rate becomes higher. The greenhouse gas management unit 240 may not only pay points depending on the energy consumption, but also subtract points held by the user, for example, when energy consumption increases.

The green product management unit (second green life management unit) 250 allows the user to increase the consumption of green products, thus allowing the user to practice the green life. In order to prompt the user to increase the consumption of green products, when the user corresponding to a card medium purchases a green product, points are assigned to the user. That is, when a product purchase list (a list of products purchased by the user corresponding to the card medium), together with card medium information, are received from the card reader terminal 100, the green product management unit 250 identifies green products included in the product purchase list, and accumulates points by applying point information corresponding to each of the identified green products or applies a discount rate to the price of each green product.

In this regard, the point information corresponding to each of the green products may be obtained from the green product information. Here, the term “green product information” denotes all information about each green product, wherein the green product information includes information about the name, identification number, related image and price of each green product, points obtained upon purchasing the green product (that is, compensation paid to a purchaser when purchasing the green product, for example, a discount rate, a point accumulation rate, accumulated points, etc.). Such green product information may be received from the affiliated company terminal 400 or may be generated by the green product management unit 250. That is, the green product management unit 250 may store green product information received from the affiliated company terminal 400. Further, the green product management unit 250 may also receive information about whether a relatively low amount of energy or relatively few resources were invested in a specific product or whether the specific product can minimize the emissions of pollutants and then determine whether the specific product is a green product, and may generate green product information for the specific product if the specific product is authenticated as a green product. For example, in the case of an electrical/electronic product, the green product management unit 250 may receive information about electricity consumed when the product is used, and if the consumed electricity is equal to or less than a predetermined reference level for a predetermined period of time, may authenticate the product as a green product and generate green product information for the authenticated electrical/electronic product. Further, in the case of a chemical product, the green product management unit 250 may receive information about each component of a chemical material such as shampoo, and if a specific component is not contained in the chemical material or if the amount of each component contained in the chemical material is equal to or less than a predetermined reference level, may authenticate the chemical material as a green product and generate green product information for the authenticated chemical material.

Since information about each green product is received from the affiliated company terminal 400 and an identifier is assigned to each green product, the management server 200 can easily identify green products from among the products included in the product purchase list. Such identifiers are implemented in the form of two-dimensional (2D) barcode or Quick Response (QR) code, and are then attached to the green products.

The public sector management unit (third green life management unit) 260 allows the user to increase the use of a public sector, thus allowing the user to lead a green life. The public sector management unit 260 may accumulate points for the user when the user visits a relevant public sector in order to stir up the necessity in the user to protect the environment. The term “public sector” denotes a place designated as protecting and promoting the natural environment, and includes, for example, national parks, recreation forests, nature museums, botanical gardens, etc., and may further include a place enabling recreation to be encouraged via the natural environment, for example, the Han River cruise ships, zoos, etc. Furthermore, the term “public sector” also includes facilities, for example, museums, provided by a local autonomous entity or a public institution so as to increase the utility of public services.

The public sector management unit 260 may receive card medium information from the card reader terminal 100 located in the public sector. and authenticate the card medium that the card medium is for user's green life management, and receive location information of the public sector (for example, the location information of the public sector may include the location information of the card medium, the location information of the card reader terminal reading the card medium or the identification information of the card reader terminal). When it is authenticated, from the location information of the public sector, that the card medium is a card medium for visiting the public sector, the public sector management unit 260 may apply a discount rate to a public sector price, or process payment using points, or accumulate points in the account of the user. The point information corresponding to each of the green products may be obtained from the public sector information. The term “public sector information” denotes all information about a public sector. The public sector information includes the name, location, ID number, related image and price information of a relevant public sector, and information about points upon using a public sector (that is, compensation paid to the user when the user utilizes the public sector, the compensation including, for example, a discount rate, a point accumulation rate, accumulated points, etc).

Meanwhile, the green consumption management unit 270 allows the user to conduct green consumption as well as to use green products, thus allowing the user to practice the green life.

The green consumption management unit 270 may give points to the user, for example, when the user presents a card medium while putting a beverage, purchased at an affiliated company which encourages green consumption, in a mug (or a personal tumbler) rather than a disposable cup. Also, the green consumption management unit 270 may give points to the user, for example, when the user takes a shopping bag to put goods purchased at the market in the shopping bag. That is, when the user conducts green consumption, if the affiliated company, which provides a service for encouraging green consumption, transmits card medium information held by the user, together with information about the green consumption activity practiced by the user, to the green consumption management unit 270 using the card reader terminal 100 located at the affiliated company, the green consumption management unit 270 may accumulate points corresponding to the green consumption in the user account, may allow the user to pay the price of a specific service or product using the points or may apply a discount to the price of the service or product, on the basis of the received information. The point information corresponding to each of the green consumption may be obtained from the green consumption information. The term “green consumption information” denotes information related to green consumption when an affiliated company provides a service for encouraging green consumption, wherein the green consumption information includes all information about environment (nature)-friendly consumption, except for all information about green products. For example, the green consumption information includes information related to whether green consumption has been performed (whether a mug has been used when purchasing a beverage, or whether a shopping basket has been used when purchasing a product), and information about points corresponding to the green consumption (that is, compensation for green consumption activity, for example, information about accumulated points, or a discount rate or a point accumulation rate applied to the prices of products/services when green consumption is associated with the purchase of products/services).

The supplementary service provision unit 280 provides a service expected for a normal card regardless of whether the service is related to the green life. The supplementary service provision unit 280 may provide, for example, a service for increasing the utility of the card medium. That is, the supplementary service provision unit 280 may induce the green life using the card medium by increasing the utility of the card medium.

Further, the supplementary service provision unit 280 may classify points into green life points accumulated based on the practice of a green life and card usage points accumulated based on the average use of cards, and provide details about the classification to the user.

Meanwhile, a green life tracking unit 290 may track the green lives practiced by a plurality of users and process feedback depending on the result of tracking the green lives.

The green life tracking unit 290 may analyze the details about green life points respectively accumulated in the plurality of users' accounts managed by the user management unit 220, provide analysis result data, and change the operation of the management server 200 using the analysis result data. That is, the green life tracking unit 290 may analyze the details about green life points accumulated by a plurality of users (all or some users registered on the management server 200) and then obtain data indicating which aspect of the green life has been practiced by each of the users to accumulate green life points. The green life tracking unit 290 may transmit the obtained data to the user terminal of each user so that the user can be aware of the data, or may change the operation of the management server 200 based on the obtained data.

For example, as a result of analyzing the details about green life points accumulated by respective users, if the green life points accumulated based on the use of green products are lower than the green life points accumulated depending on the practice of other aspects of the green life, analysis result data indicating that the use of green products is a smaller proportion of the practice than that for other aspects of the green life can be obtained. The management server 200 may perform feedback to increase the rate of use of green products (for example, to allow the green product management unit 250 to increase accumulated green life points [or a point accumulation rate, a discount rate, or the like] corresponding to green products) using the data.

Further, the green life tracking unit 290 may track and analyze the location where the use of card media for green life management occurred, analyze a location at which a green life has been actively practiced, a location at which a green life has been inactively practiced, etc., provide analysis result data, and then change the operation of the management server 200 based on the data.

For example, when the use of card media for a green life conducted in Gwanak district is the least compared to any other districts in Seoul, the green life tracking unit 290 may analyze the cause of the accumulation of the low green life points (for example, the accumulation of green life points for a specific aspect of the green life is considerably lower than that of other districts) based on the details about the accumulation of green life points by users in Gwanak district, and transmit the analysis result data to the user so that the user is aware of the data, or allow the management server 200 to perform feedback (to perform the operation of encouraging the specific aspect of the green life, e.g. by performing the operation of increasing accumulated green life points [or an accumulation rate, a discount rate, or the like] corresponding to the specific aspect of the green life) based on the data.

Further, for example, in the case where the use of card media for a green life conducted in market A is the least compared to other markets, the green life tracking unit 290 may surmise that the sales of green products in market A are the lowest and send a message indicating that the sales of green products are low to the user terminal of the manager of market A, or operate the management server 200 so that green life points accumulated upon purchasing green products in market A are changed.

The communication unit 291 performs communication required for the operation of the management server 200. The communication unit 291 may perform communication between, for example, the components of the management server 200. Further, the communication unit 291 may perform communication with the card reader terminal 100, the energy measurement terminal 300, the affiliated company terminal 400 or the user terminal 500.

The storage unit 292 stores all pieces of information required for the operations of the individual components of the management server 200, and transmits the information when a request for the information is received. For example, the storage unit 292 may store information that corresponds to the account of the user and that is received from the user management unit 220. Also, for example, the storage unit 292 may store location information which corresponds to the identification information of the card reader terminal.

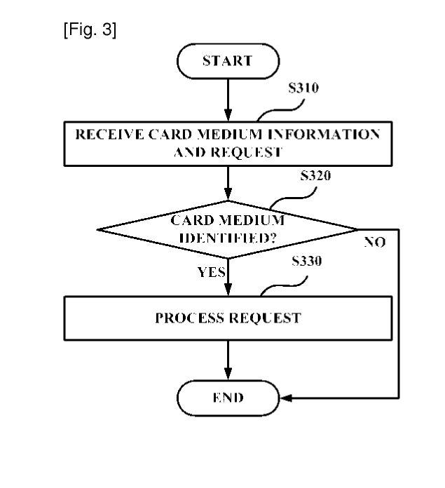

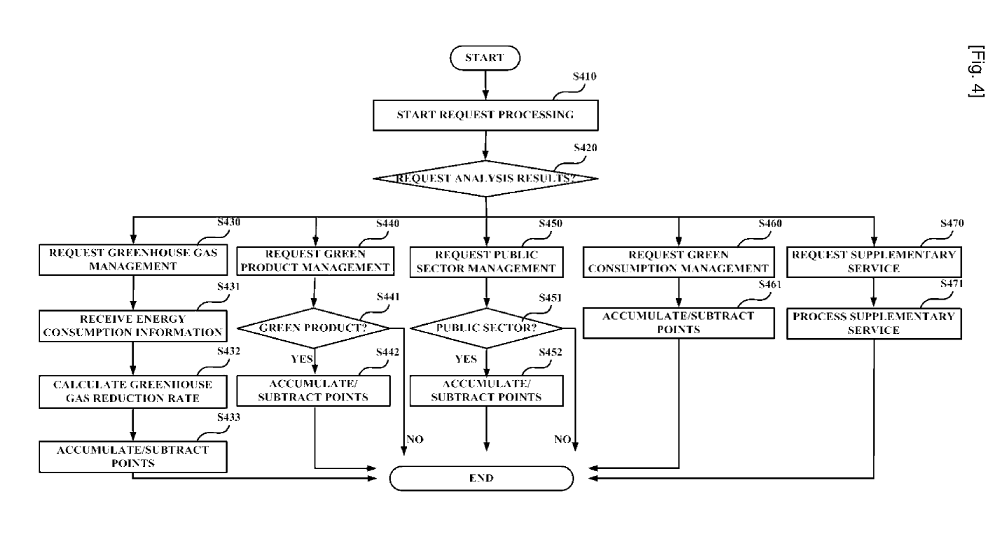

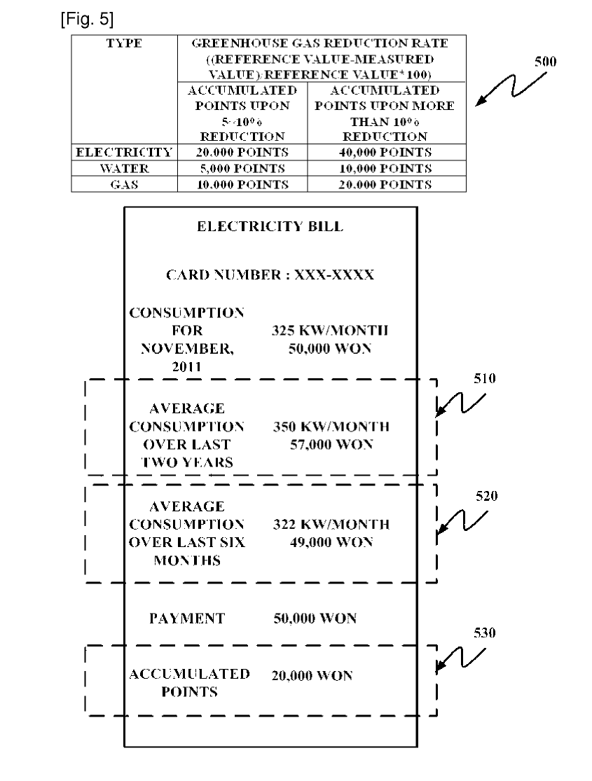

FIGS. 3 and 4 are flowcharts showing a green life management method performed by the green life management system according to an embodiment of the present invention. Such a green life management method will be described below with reference to FIGS. 3 and 4 together with FIGS. 5 to 8. In the following description, for convenience, a card medium is assumed to be a credit card.

First, in the method according to the embodiment of the present invention, it is premised that the card has been registered in the management server 200. That is, the account of the user corresponding to the card is generated in the management server 200. Accordingly, when the card medium information of the card is transmitted to the management server 200 via the card reader terminal 100, the management server 200 may identify the card and also identify the account of the user corresponding to the card.

That is, when card medium information and a request are received at step S310, the management server 200 may identify the card medium based on the card medium information at step S320. If the card medium is a card that is not registered, the process of the present invention may be terminated. The management server 200 may identify the card based on the received card medium information and obtain information about the account of the user corresponding to the card. Thereafter, the management server may process the received request at step S330. A procedure for processing the request will be described below with reference to FIG. 4.

As shown in FIG. 4, at step S330, when receiving the request, the management server 200 processes the request at step S410. In this case, in order to process the request, the management server 200 may analyze the type of request that has been received, and proceed to processes based on the results of the analysis at step S420.

If the received request is a request regarding greenhouse gas emissions (for example, a payment request for energy consumption) at step S430, the management server 200 receives (or obtains) information about energy consumed by a user corresponding to the card at step S431, extracts a measured value from the energy consumption information, compares the measured value with a reference value, and then accumulates points when the measured value is less than the reference value by a predetermined rate or more at step S433.

For example, as shown in FIG. 5, a table 500 for points that are accumulated depending on the greenhouse gas reduction rate is stored in advance, points to be accumulated depending on the greenhouse gas reduction rate of the user are searched for in the table 500, and the points returned by the search are paid to the account of the user. In this case, as the reduction rate is higher, the amount of money corresponding to the paid points is larger. By means of this, the user may have a motivation to increase the reduction rate.

The greenhouse gas reduction rate can be calculated by the following equation:

Greenhouse gas reduction rate (%)=((energy consumption reference value-energy consumption measured value)/energy consumption reference value)*100

The reference value is a value that is a reference for calculating the greenhouse gas reduction rate, and may be, for example, the average energy consumption of a random group, or the average energy consumption of the user over the last predetermined period. Such a reference value may be calculated using the energy consumption information of the user or pieces of energy consumption information of a plurality of users. Meanwhile, the measured value is a value obtained by measuring energy consumed by the user using the energy measurement terminal 300, and may be the value measured for one month based on the current time point or may be the average of values measured over several months so as to calculate the greenhouse gas reduction rate.

For example, when the greenhouse gas reduction rate is calculated based on electricity consumption, the average (520) of electricity consumed by the user over the last six months on the basis of this month (November in 2011) is set to the measured value, and the average (510) of electricity consumed by the user over the last two years on the basis of this month (November in 2011) is set to the reference value, as shown in FIG. 5. In this case, it can be seen that the greenhouse gas reduction rate is 8% (=((350−322)/(350))*100), and that when a point payment corresponding to the greenhouse gas reduction rate is obtained from the table 500, the points paid to the user are 20,000 points (530). Then the user may receive electric bill through the user terminal that shows the accumulated points by energy reduction, thus inspiring the user to purchase green products.

In this way, when the point payment is determined, the points are accumulated in the account corresponding to the card.

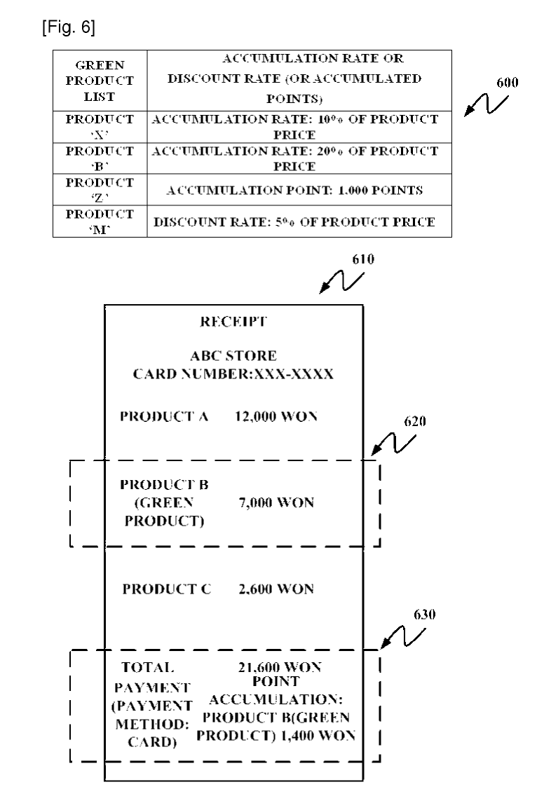

Meanwhile, if the received request is a request regarding the management of a green product (for example, a payment request for a green product) at step S440, a process based on the request is performed. That is, when additional information (that is, a product purchase list), together with the request, are received (or obtained), it is determined whether a green product is present in products included in the product purchase list at step S441. That is, if a green product is included in the product purchase list, points corresponding to the green product are accumulated, or a discount rate is applied to the price of the product at step S442. For example, as shown in FIG. 6, the management server 200 stores a green product list 600, which is received from the affiliated company terminal 400 and is then registered. When the user purchases product A, product B, and product C, a list of products A, B, and C is generated as a product purchase list, and is transmitted to the management server via a card reader medium. When the product purchase list is received, the management server determines that product B, a green product, is present in the product purchase list, and accumulates points for the product B in the account of the user. Thereafter, when the user purchases a green product, he or she receives a receipt 610 via the card reader terminal, and is then aware that certain points have been accumulated (630) because the user purchased product B which is the green product (620). That is, when a green product is purchased, points corresponding to that green product are accumulated or a corresponding discount rate is applied, and the results of accumulation/application are reported to the user, thus inspiring the user to purchase green products.

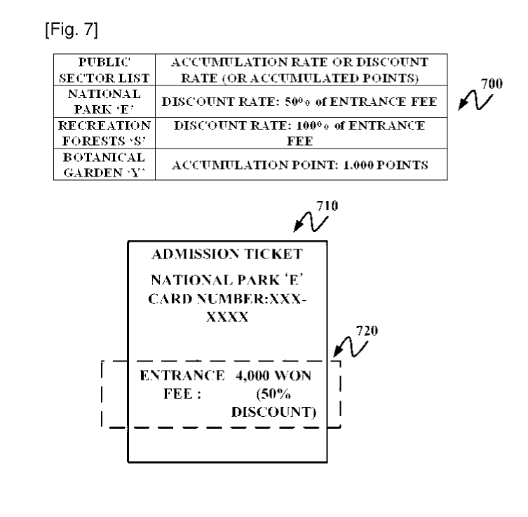

Meanwhile, if the received request is a request regarding the management of a public sector (for example, a payment request for the use of a public sector) at step S450, a process based on the request is performed. That is, when the user uses(or visits) the public sector, location information of the public sector (the location information of the card medium or the terminal identification information of the card reader terminal), together with the card medium information of the card, are received (or obtained), and it is determined whether the place in which the card medium is used is part of the public sector at step S451. Using a table 700 (of FIG. 7) which contains the public sector information and is received from the affiliated company terminal 400 and is stored, a discount is applied to the price of the use of the public sector or corresponding points are accumulated at step S442.

For example, as shown in FIG. 7, when the user visits national park E and uses a card to enter the park E, the management server 200 may receive card medium information and information about the usage of the card, that is, location information, from the card reader terminal 100. On the basis of the location information, whether the place at which the card is used is in the public sector can be determined. According to the table 700, since national park E is in the public sector, a discount rate of 50% is applied, so that only 4,000 Won (720) which is 50% of an entrance fee is charged to the user. In this way, whenever the public sector is used, compensation is paid and this payment is reported to the user (710), so that the user is inspired to use the public sector to forgo recreational activities that emit greenhouse gases. Further, when the public sector is related to the natural environment, the user can be aware of the importance of practicing a green life by stirring up the importance of the natural environment. Further, since recreation can be enjoyed using the natural environment, the utility of the existing resources can be improved, and additional resource consumption can be prevented, thereby enabling resources to be saved and a green life wherein carbon is reduced to be practiced.

Meanwhile, if the received request is a request regarding the management of green consumption (for example, a payment request for green consumption other than the purchase of green products) at step S460, a process based on the request is performed. That is, when information about green consumption (information about which type of green consumption has been conducted, that is, information about the type of green consumption), together with the request, are received (or obtained), points are accumulated or a discount rate is applied to a service or a product desired to be purchased by the user together with the request, according to the received information, at step S461. For example, it is assumed that the user conducts green consumption in such a way as to perform the action of putting items purchased at a store, which registered a green consumption encouragement service, in a shopping basket instead of a disposable vinyl bag. If the fact that this action has been conducted is transmitted to the management server via the card reader medium, the management server may accumulate points corresponding to green consumption information related to such green consumption activity in the account of the user or may apply a discount rate to the price of the purchased product, and may notify the user of the results of accumulation/application, thus inspiring the user to conduct green consumption activities.

Meanwhile, if the received request is a request regarding a supplementary service at step S470, a process based on the request is performed. That is, a process corresponding to the requested supplementary service is performed at step S471. The term “supplementary service” denotes a typical service added to a card so as to increase the use of the card regardless of whether the service is related to the green life, and those skilled in the art can expect which types of services are supplementary services.

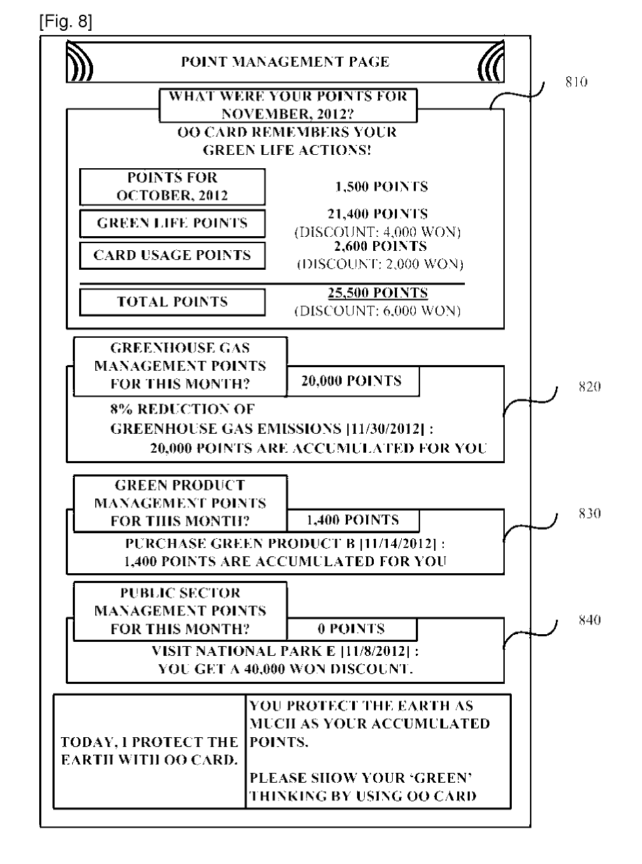

Further, the term “supplementary service” may denote a service such as a service for increasing a point accumulation rate depending on the amount of money used using the card, or a discount or point accumulation service provided when an affiliated food store, movie theater, or public transportation means (a bus, a subway, etc.) is used. Further, the term “supplementary service” may refer to a service for converting the accumulated points into cash and paying the cash to the user, or a service for subtracting accumulated points and providing a commodity or a service corresponding to the subtracted points. Furthermore, the term “supplementary service” may refer to a service for allowing the user to purchase a product, for example, a green product, using accumulated points. Furthermore, the term “supplementary service” may be a service for allowing the user, who uses a relevant card, to inquire about the amount deducted from his or her income attributable to the use of the card. Upon making the deduction from the income, the amount deducted attributable to the use of the card, and the amount deducted attributable to the practice of the green life may be separately inquired about. Furthermore, the term “supplementary service” may refer to a service or allowing the user to inquire about points accumulated in the card. Therefore, when the user desires to access the management server using the user terminal and inquire about accumulated points, the details of the points accumulated by the user may be shown to the user, as shown in FIG. 8. In FIG. 8, details of points accumulated by practicing green life and by typical card using are shown (810), and which aspect of the green life has been practiced to accumulate the points (820, 830, and 840) is also shown, thus inspiring the user to better lead the green life. For example, when the user reduces greenhouse gas emissions by reducing the consumption of electricity, gas, and water, accumulated points or a discount (820) obtained depending on the greenhouse gas reduction rate, accumulated points or a discount (830) obtained depending on the purchase of green products when the user purchases the green products, and accumulated points or a discount (840) obtained when the user visits the public sector, are individually shown, thus allowing the user to feel the direct impact of the profit caused by the green life (that is, accumulated points), and consequently inspiring the user to lead the green life.

Further, the management server may track green lives practiced by the plurality of users, separately from the step S410 of receiving the request, either periodically or randomly, and process feedback based on the result of tracking the green lives.

In this way, the green life management system organically performs the management of the green life, that is, the management of greenhouse gas emissions, the management of green products (that is, the encouragement of green product consumption), and the management of the public sector (that is, the encouragement of the use of the public sector), thus allowing the user to check the green life practiced by the user. Further, the green life management system can unify and accumulate points regardless of which aspect of the green life has been practiced, thus removing any difficulty found when practicing the green life, and providing motivation to practice the green life.

Further, the green life management system may classify and separately provide details about points accumulated based on the practice of a green life, so that a user can definitely know which life is a green life, thus presenting a guide for practicing a green life. Furthermore, the green life management system can analyze green lives of a plurality of users, thus changing the operation of the system so that green lives can be improved/encouraged.

The above embodiments are only examples for describing the present invention in detail, and the present invention is not limited to these embodiments. Those skilled in the art will appreciate that various additions, omissions and substitutions and other modifications are possible, without departing from the scope and spirit of the invention as disclosed in the accompanying claims. The present invention is not limited by the above descriptions and are limited only by the accompanying claims.

### INDUSTRIAL APPLICABILITY

As described above, the present invention is advantageous in that the green life of typical consumers can be efficiently managed. Further, the present invention is advantageous in that the green life can be conveniently practiced using a card medium. Furthermore, the present invention is advantageous in that a green life consumption platform can be provided using a card medium.

1. A green life management system managing a green life of a user by using a card medium of the user, comprising:
a card reader terminal configured to read card medium information of the card medium; and
a management server configured to communicate with the card reader terminal and receive the card medium information,
wherein the management server comprises:
a first green life management unit configured to receive energy consumption information of the user, calculate points based on the card medium information and the energy consumption information, and transmit the points to a point management unit;
a second green life management unit configured to receive a product purchase list of the user, extract a green product list from the product purchase list, calculate points based on the card medium information and the green product list, and transmit the points to the point management unit; and
the point management unit configured to accumulate the received points in an account of the user, classify the accumulated points based on the energy consumption information and the green product list, and transmit details about the classification to a user terminal of the user,
wherein the management server further comprises a third green life management unit configured to receive a location information of a public sector including at least one of the location information of the card medium, the location information of the card reader terminal, and terminal identification information, extract whether the card medium is used for managing the public sector from the location information of the public sector, calculate points based on the extracted information and the card medium information, and transmit the points to the point management unit, wherein the public sector is a place designated as protecting and promoting the natural environment.

2. The green life management system according to claim 1, further comprising an energy measurement terminal configured to measure energy consumption of the user and generate energy consumption information about the measured energy consumption.

3. The green life management system according to claim 1, wherein the first green life management unit is further configured to extract a reference value and a measured value from the energy consumption information, calculate a greenhouse gas reduction rate based on the reference value and the measured value, and calculate points based on the greenhouse gas reduction rate.

4. The green life management system according to claim 3, wherein:
the greenhouse gas reduction rate is calculated by the following equation:
greenhouse gas reduction rate (%)=((energy consumption reference value-energy consumption measured value)/energy consumption reference value)*100,
the reference value is an average of energy consumed by the user over a first period,
the measured value is an average of energy consumed by the user over a second period, and
the first and second periods are inversely calculated from a time point at which the greenhouse gas reduction rate is calculated, and the second period is shorter than the first period.

5. The green life management system according to claim 3, wherein the first green life management unit is further configured to calculate higher points as the greenhouse gas reduction rate is higher.

6. (canceled)

7. A green life management method managing a green life of a user by using a card medium of the user, comprising:
receiving card medium information about the card medium and a request of the user;
analyzing the request;
accumulating points in an account of the user depending on the analyzed request; and
classifying the accumulated points based on an energy consumption information and a green product list, and transmitting details about the classification to a user terminal of the user,
wherein the accumulating the points comprises:
if the analyzed request is a request regarding greenhouse gas emissions, obtaining the energy consumption information of the user, calculating points based on the card medium information and the energy consumption information, and accumulating the points;
if the analyzed request is a request regarding purchase of a green product, obtaining the product purchase list of the user, extracting a green product list from the product purchase list, calculating points based on the card medium information and the green product list, and accumulating the points; and
if the analyzed request is a request regarding the management of a public sector, obtaining a location information of the public sector including at least one of the location information of the card medium, the location information of the card reader terminal, and terminal identification information, extracting whether the card medium is used for managing the public sector from the location information of the public sector, calculating points based on the extracted information and the card medium information, and accumulating the points, wherein the public sector is a place designated as protecting and promoting the natural environment.
